(19) United States
(12) Patent Application Publication
(10) Pub. No.: US 2025/0272993 A1
(43) Pub. Date: Aug. 28, 2025

(54) METHOD FOR PARTITIONING A DISTRIBUTED DETECTION OF THREE-DIMENSIONAL OBJECTS

(71) Applicant: Robert Bosch GmbH, Stuttgart (DE)

(72) Inventors: Andreas Wuestenberg, Geldern (DE); Christian Herrmann, Leinfelden-Echterdingen (DE); Eva Zimmermann, Reutlingen (DE); Veronika Kohler, Herrenberg (DE)

(21) Appl. No.: 19/058,640

(22) Filed: Feb. 20, 2025

(30) Foreign Application Priority Data
Feb. 27, 2024 (DE) 10 2024 201 796.5

(51) Int. Cl. G06V 20/64; G06N 3/04; G06V 10/82; G06V 20/52; G06V 20/56

(52) U.S. Cl. CPC G06V 20/64; G06N 3/04; G06V 10/82; G06V 20/52; G06V 20/56

(57) ABSTRACT

A method for partitioning a distributed detection of three-dimensional objects from captured data. A neural network distributed across at least one sensor compute node and one aggregation compute node is used. Each sensor compute node is assigned at least one sensor which captures data from its environment. The sensor compute nodes forward evaluated data to the aggregation compute node. The partitioning is carried out on a common three-dimensional representation.

### CROSS REFERENCE

The present application claims the benefit under 35 U.S.C. § 119 of German Patent Application No. DE 10 2024 201 796.5 filed on Feb. 27, 2024, which is expressly incorporated herein by reference in its entirety.

### FIELD

The present invention relates to a method for partitioning a distributed detection of three-dimensional objects, and to a neural network suitable for carrying out the method.

### BACKGROUND INFORMATION

The method presented here is in particular applicable in the field of automated driving. Automated driving requires detection or perception of the vehicle's environment. Cameras are usually used as sensors for this purpose, which capture the environment in order to detect relevant objects in the environment from the captured data, in particular image data. Conventional methods for detecting three-dimensional objects from multi-sensor/multi-view data transform abstract representations of data from each individual sensor into a common or unified three-dimensional representation, wherein the abstract representations are collected or aggregated and used to predict three-dimensional objects.

These methods are usually carried out on a single machine or on a single compute node. With a growing number of sensors involved, methods that perform three-dimensional multi-sensor/multi-view object detection on a single compute node have significant limitations due to the amount of incoming raw sensor data, a lack of redundancy, and inflexible scalability.

A conventional method for distributed execution across a plurality of compute nodes, which is mainly used to reduce latency in an edge device and in cloud arrangements, is distributed deep neural network (DNN) inference. DNN model partitioning usually occurs at a low level of abstraction (low level), for example, by splitting the sensor space input data of a single sensor based on a dynamic load balancing mechanism and on processing each part on a different compute node.

This may mean, for example, that an image is cut into different patches and each patch is processed on a separate compute node with some communication between compute nodes for correct results. There are also rudimentary distributed inference strategies for classification methods for multi-sensor/multi-view data, but none for three-dimensional object detection, wherein low-level sensor space features are aggregated across a plurality of compute nodes before being transformed into a three-dimensional representation.

Applying low-level DNN partitioning and multi-node distribution mechanisms from the related art make scaling possible, but there is a lack of sufficient semantic meaning in the sensor space where the partitioning takes place. Meaningful semantic redundancy and scalability are not achieved, which makes correct system design difficult.

### SUMMARY

The present invention includes a method and a neural network. Example embodiments of the present invention can be found in the disclosure herein.

According to an example embodiment of the present invention, a method for partitioning a distributed detection of three-dimensional objects from captured sensor data is provided, wherein a neural network distributed across at least one sensor compute node and one aggregation compute node is used, each sensor compute node is assigned at least one sensor which captures data from its environment, the sensor compute nodes forward evaluated data to the aggregation compute node, and the partitioning is carried out on the common or unified three-dimensional representation.

A neural network is a network of artificial neurons and has a natural biological model. Natural neural networks represent a network of neurons in the nervous system. A deep neural network (DNN) mimics the functioning of the human brain.

According to an example embodiment of the present invention, the neural network presented here is designed, for example, as a deep neural network and is configured to carry out a method of the type described here.

According to an example embodiment of the present invention, a method for partitioning a distributed execution of a detection of three-dimensional objects is provided, which provides a direct relationship between partitioning and spatial regions and thus a higher, more human-understandable meaning content. This makes better, more targeted, resilient and scalable system-level designs based on three-dimensional geometry possible. It also makes saving bandwidth possible.

According to an example embodiment of the present invention, it is provided to partition and distribute the method for detecting three-dimensional objects directly at its common or unified three-dimensional representation (230 in FIG. 1), in which the individual sensor representations are aggregated. Three-dimensional representations, which are structurally similar to the real three-dimensional world and consequently have a human-understandable geometric meaning at a higher level of abstraction (high level), are thus transferred between the compute nodes. In practical implementation, this leads to a partitioning into sensor compute nodes that process sensor data and transform them into a three-dimensional representation. All three-dimensional representations are then sent to an aggregation compute node, which computes the common or unified three-dimensional representation. Exploiting the geometric and mathematical quantities or properties of the three-dimensional representation offers advantages in terms of partitioning, such as:
A) Easy system scalability is achieved for both additional sensors per sensor compute node and additional sensor compute nodes connected to the aggregation compute node. In both cases, the partitioning, including the interfaces, of the rest of the distributed system remains unaffected.
B) An explicit resilience design, when a plurality of overlapping sensors are provided across different compute nodes and the same region in the three-dimensional world is considered, is made possible.
C) Fixed partitioning of the algorithm or load and fixed-size data blocks transferred between compute nodes, instead of dynamic load balancing or variable-size data blocks, make real-time processing possible.
D) Implicit bandwidth savings are achieved, since the three-dimensional representation is or can be designed to be smaller than raw sensor data or low-level features.
E) Explicit bandwidth savings between compute nodes are achieved by aggregating the three-dimensional representations from all sensors on the corresponding sensor compute node and/or by transferring only the parts of the three-dimensional representation within the field of view of the contributing sensors.
F) Training DNN-based three-dimensional object detection methods as a whole (end-to-end) is possible without having to consider the proposed partitioning methods at training time. Partitioning can be applied retrospectively.

Further advantages and embodiments of the present invention can be found in the description and the figures.

Of course, the features mentioned above and those still to be explained below can be used not only in the respectively specified combinations but also in other combinations or alone, without departing from the scope of the present invention.

### BRIEF DESCRIPTION OF THE DRAWING

FIG. 1 shows a block diagram of a basic processing chain for a method for detecting three-dimensional objects, according to an example embodiment of the present invention.

FIG. 2 shows a block diagram of a partitioning for a distributed execution of a method for detecting three-dimensional objects, according to an example embodiment of the present invention.

FIG. 3 shows a block diagram of a partitioning for a distributed execution of a method for detecting three-dimensional objects with a pre-aggregation of the three-dimensional representations on a sensor compute node, according to an example embodiment of the present invention.

FIG. 4 shows an exemplary three-dimensional representation using a grid from a bird's eye view.

### DETAILED DESCRIPTION OF EXAMPLE EMBODIMENTS

The present invention is shown schematically in the figures on the basis of example embodiments and is described in detail below with reference to the figures.

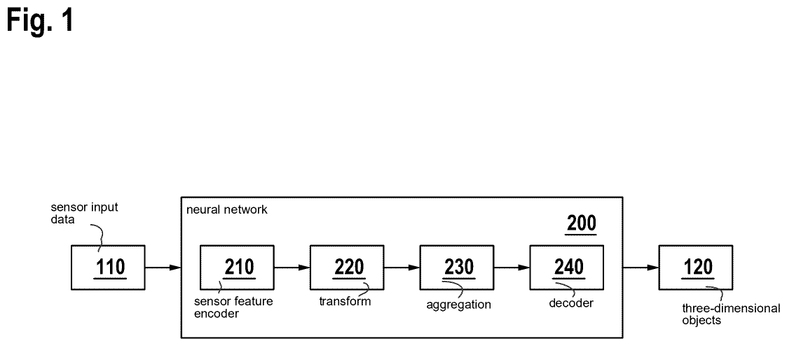

FIG. 1 shows a block diagram of a basic processing chain for a method for capturing three-dimensional objects. The illustration shows sensor input data 110, three-dimensional objects 120, a neural network 200 for detecting three-dimensional objects, a sensor feature encoder 210, a unit 200 for transforming sensor features into a three-dimensional representation, an aggregation 230 of the three-dimensional representations from a plurality of sensors, and a decoder 240 for three-dimensional representations.

What follows is a detailed description based on the exemplary use case of automated driving with a sensor configuration consisting of a plurality of cameras which capture the world from different angles or views, wherein a DNN-based three-dimensional object detector is used.

The method is not limited to this specific use case. It is also used with sensors that are not cameras, e.g., lidar, radar, ultrasound, etc. The method is also applicable to sensor configurations designed for other application areas that aim at environmental detection, such as in robotics in a more general sense or in surveillance systems with spatially distributed sensors. The method is in particular applicable to sensors whose fields of view overlap.

It should also be taken into account that transferred data blocks can have a fixed size.

The basic signal and processing chain of a non-distributed three-dimensional object detection method is shown in FIG. 1. One or more camera images, as sensor input data 110, are input into the three-dimensional object detection network 200, which predicts three-dimensional objects 120 as output, e.g., as a bounding box. The sensor input data 110 are each provided by a sensor, e.g., a camera.

Each camera image is encoded into low-level image space features by means of the sensor feature encoder 210 and subsequently transformed from the image space into a three-dimensional spatial presentation by means of the unit 220. Then, three-dimensional per-camera representations from a plurality of cameras are aggregated into a common or unified three-dimensional representation 230, which is subsequently decoded into a unified list of three-dimensional objects with the decoder 240. Beyond a list of three-dimensional objects, the three-dimensional representation can also be the basis for other detection tasks and object representations, such as segmentation, instance masking or spatial occupancy, where the proposed method is also applicable.

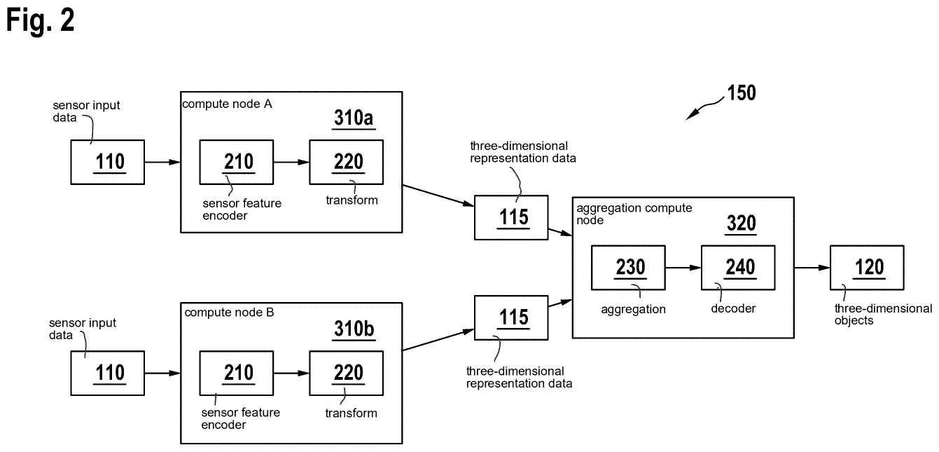

The proposed partitioning strategy for a distributed execution of the three-dimensional object detection method is shown in FIG. 2.

FIG. 2 shows a neural network 150 for the detection of three-dimensional objects, which is distributed across sensor compute nodes 310, namely compute node A 310a and compute node B 310b, and an aggregation compute node 320. Optionally, a sensor compute node 310 may also assume the role of the aggregation compute node 320 simultaneously. There may also be more than one aggregation compute node 320, for example in order to provide redundancy. The number of sensor compute nodes 310 is arbitrary and can vary freely. On the hardware side, a compute node can be represented, for example, by a chip, a dedicated computational accelerator, or a complete computer system. Partitioning is proposed after transformation from the sensor space into the three-dimensional representation by means of the unit 220, and the three-dimensional representation data 115 are sent from the sensor compute node 310 to the aggregation compute node 320.

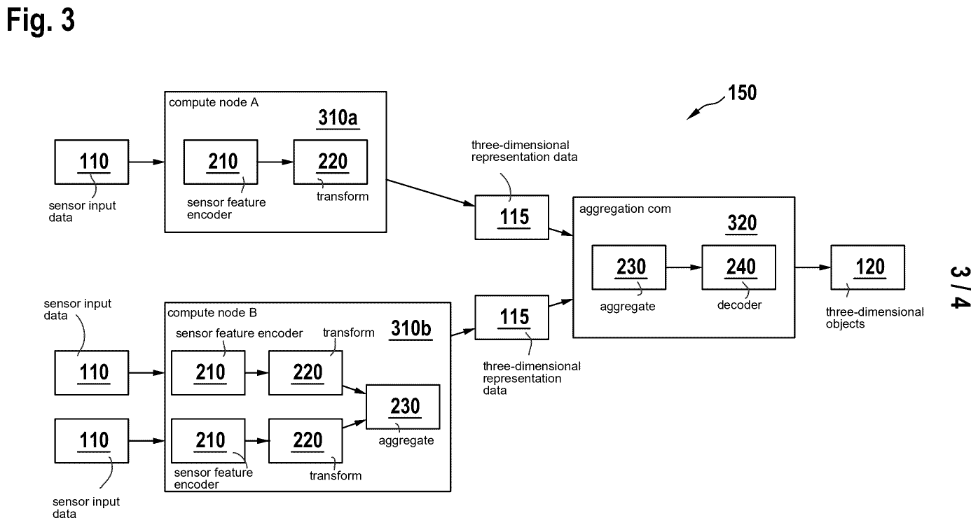

If a plurality of cameras are assigned to a sensor compute node 310b, as shown in FIG. 3 (compute node B), the three-dimensional representations 230 for these cameras may already be pre-aggregated on the sensor compute node 310b before being sent to the aggregation compute node 320, in order to save bandwidth. The number of sensors per sensor compute node 310 is arbitrary and can vary from one sensor compute node 310 to the other. Sensor types/modalities can also be mixed arbitrarily, even on a sensor compute node 310. From a mathematical point of view, pre-aggregation requires only an associative aggregation function, such as sum, average, minimum, or maximum, which are common choices.

The unified three-dimensional representation 230 may have less storage requirements than raw sensor data 110 or lower-level features.

It may furthermore be provided that only parts of the unified three-dimensional representation 230 are transferred to the aggregation compute node 230.

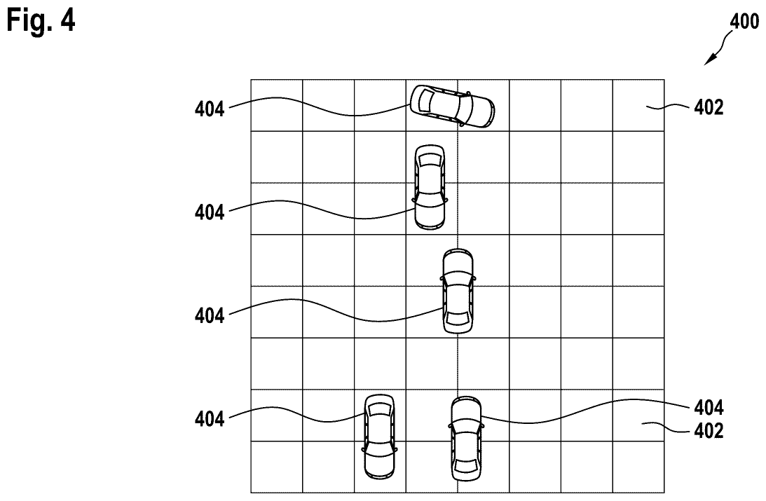

In order to leverage some of the advantages of the proposed partitioning strategy, certain other extensions and properties of the three-dimensional representation 220 and aggregation functions become essential. The following explanations and details assume, by way of example, the three-dimensional spatial representations by the unit 220 to be a projection into a two-dimensional Euclidean grid from a bird's eye view, as shown in FIG. 4. However, the concept can also be applied to other three-dimensional spatial representations, such as various projections, voxels and polar representations.

FIG. 4 shows an exemplary three-dimensional representation 400 of a vehicle environment in a bird's eye view with a number of cells 402. The scope shown, the number of cells and the objects, in this case vehicles 404, are arbitrary.

The above-mentioned advantages are discussed in more detail below:
A) The numerical value range of the individual elements in the grid from a bird's eye view is invariant to the number n of cameras involved. How this can be achieved depends on the aggregation function used. The minimum or maximum functions, for example, are inherently invariant for this purpose. If the average of the representations Rᵢ is used, a weight wᵢ, which represents the number of sensors involved in this grid in bird's eye view, can be sent along with each R₁ so that:

R_{aggregated}=ΣᵢRᵢ/Σᵢwᵢ

is invariant in the numerical scaling to n. All valid Rᵢ on a sensor can also be summed up there. Such an aggregation benefits the sensor/compute node failure resilience (B) as well as the scalability of the system in case more compute nodes or sensors should be added.
B) Since the geometric structure of the three-dimensional representation is similar to the relevant part of the three-dimensional world, system resilience and redundancy can be directly designed to meet certain criteria in an obvious and understandable way. By processing all data of a sensor on a sensor compute node, the field of view and redundancy considerations are directly connected to the sensor compute nodes. Combined with a suitable aggregation function, as described under point A, redundancy and thus increased resilience can be added to the system, without changes to the overall partitioning, interfaces, and system design. For example, if the region in front of the ego vehicle of an automated driving system should be redundantly covered with independent cameras and compute nodes, this criterion can easily be reflected in the system design, wherein the proposed partitioning strategy is used: there are two groups, each with an appropriate number of cameras, with both groups covering the relevant field of view and thus providing redundancy of the sensors. Each group is assigned to its own sensor compute node, whose outputs are connected to one or more aggregation compute nodes. This ensures coverage in the event of problems with either a sensor or a compute node.

Low-level partitioning mechanisms do not provide such easy traceability due to the sensor data of each individual sensor being distributed across compute nodes. This means that failure of a compute node can affect not only known three-dimensional regions but any set of outputs or all outputs. It should also be noted that the proposed partitioning makes it possible to distribute a plurality of instances of the aggregation compute node on independent hardware in order to increase resilience if required. Sensor compute node outputs simply need to be sent to all aggregation compute nodes in parallel.
C) Conventional distributed DNN inference methods for use cases in the field of edge and cloud computing, e.g., consisting of smartphone applications and cloud servers, try to reduce latency through adaptive strategies, wherein variable parts of the data are sent from the edge devices to the cloud. While this offers flexibility in dynamically changing systems, e.g., by varying data bandwidths or computing power, this is not suitable for real-time applications. The proposed partitioning is thus based on fixed-size data blocks, wherein the size of the transferred data as well as the computational steps to be executed on a specific compute node are known and determined in advance. This is the basis for real-time applications where predictability is required.
D) In automated driving applications, raw sensor data, in particular camera data, tend to be of significant size due to their high resolution. Consequently, even low-level features are very large since their size increases linearly with the sensor resolution. Conventional partitioning strategies that transfer raw sensor data or low-level features with high-resolution therefore require significant bandwidth between the compute nodes. In contrast, the size of the bird's eye view grid is independent of the sensor resolution and can be designed depending on the needs of the object detection functionality and thus also smaller than raw data or low-level data. This leads to reduced bandwidth requirements between compute nodes.
E) If a suitable aggregation function is used, such as described in A, all bird's eye view grids of the cameras assigned to a sensor compute node can be aggregated in advance there and the amount of data transferred to the aggregation node is reduced and is of fixed size, e.g., independently of the number of cameras assigned to the sensor compute node. Furthermore, the bird's eye view representation in the device memory typically makes it possible to efficiently access specific patches, e.g., a rectangular region representing a specific area of the world.

Thus, only the patch covered by the field of view of the cameras involved needs to be transferred to the aggregation compute node along with a small amount of metadata describing the location of the patch in the complete bird's eye view grid. More elaborate and further cropped regions than rectangular regions are possible but must be considered in terms of the increased amount of metadata required to describe their shape. When real-time capability is important and for sensor configurations with a fixed field of view within the three-dimensional representation, the metadata can be communicated to the aggregation compute node before online execution, in order to avoid additional bandwidth usage.
F) Model training of DNN-based three-dimensional object detection methods is typically already a non-trivial task. The proposed partitioning strategy has no retroactive impact on DNN training and therefore prevents increased complexity.

What is claimed is:

1. A method for partitioning a distributed detection of three-dimensional objects from captured data, in which a neural network distributed across at least one sensor compute node and at least one aggregation compute node is used, the method comprising the following steps:
assigning each sensor compute node at least one sensor which captures data from its environment;
forwarding by the sensor compute nodes evaluated data to the aggregation compute node; and
carrying out the partitioning on a common three-dimensional representation.

2. The method according to claim 1, wherein a plurality of sensors are connected to at least one sensor compute node of the at least one sensor compute node.

3. The method according to claim 1, wherein the method is carried out in a motor vehicle configured for automated operation.

4. The method according to claim 1, wherein the method is carried out in a field selected from a group including: robotics, surveillance systems.

5. The method according to claim 1, wherein the at least one sensor are selected from a group including: camera, lidar sensor, radar sensor, ultrasonic sensor.

6. The method according to claim 1, wherein the at least one sensor includes sensors whose fields of view overlap are used.

7. The method according to claim 1, wherein the detection is performed according to the partitioning carried out.

8. The method according to claim 1, wherein the detection is performed in real time.

9. The method according to claim 1, wherein the detected objects are shown in a representation in a bird's eye view.

10. The method according to claim 1, wherein the method is carried out in a deep neural network.

11. A neural network distributed across at least one sensor compute node and one aggregation compute node and configured to partition a distributed detection of three-dimensional objects from captured data, the neural network configured to perform the following steps:
assigning each sensor compute node at least one sensor which captures data from its environment;
forwarding by the sensor compute nodes evaluated data to the aggregation compute node; and
carrying out the partitioning on a common three-dimensional representation.

12. The neural network according to claim 11, wherein the neural network is a deep neural network.
